(19) United States
(12) Patent Application Publication
(10) Pub. No.: US 2008/0041249 A1
(43) Pub. Date: Feb. 21, 2008

(54) Image Transfer Sleeve and Offset Printing Press Provided with an Image Transfer Sleeve of This Type

(75) Inventor: Etienne Alfons D'Hauwe, Schilde (BE)

Correspondence Address: HOFFMANN & BARON, LLP, 6900 JERICHO TURNPIKE, SYOSSET, NY, 11791, US

(73) Assignee: DRENT HOLDING B.V., Hall (NL)

(21) Appl. No.: 11/719,034

(22) PCT Filed: Nov. 17, 2005
(86) PCT No.: PCT/NL05/00799

§ 371 Date: May 10, 2007

(30) Foreign Application Priority Data
Nov. 19, 2004 (NL) 1027555

(51) Int. Cl. B41F 30/04

(52) U.S. Cl. 101/217; 428/909

(57) ABSTRACT

An image transfer sleeve (111) is designed to be removable fitted around a mandrel of an offset printing press and comprises a printing cylinder sleeve (110) and an image transfer blanket (100). The image transfer blanket. (100) Extends around the printing cylinder sleeve (110) and is connected to the printing cylinder sleeve (110) by means of adhesive force. Two opposite edges (102, 104) of the image transfer blanket (100) form a seam (113). The seam (113) is at least partially wavy. The image transfer blanket (100) is present along at least part of each describing line of the peripheral surface of the image transfer sleeve (111).

The invention relates to an image transfer sleeve according to the preamble of claim 1. Such an image transfer sleeve is intended to be fitted around a mandrel of an offset printing press and in that case functions as an image transfer cylinder. With an offset printing press of this type, the image transfer cylinder transfers ink from a plate cylinder to a substrate to be printed, for example cardboard, paper, film or labels. To this end, the substrate is fed through between the image transfer sleeve and a third cylinder. The plate cylinder, the image transfer cylinder and the third cylinder exert great pressure on one another in order to ensure satisfactory transfer of the ink between the plate cylinder and image transfer cylinder, and between the image transfer cylinder and the substrate.

An image transfer sleeve is known from WO 2004/065123. FIG. 12 and the associated description of that publication disclose an exchangeable image transfer sleeve which comprises a printing cylinder sleeve and a rubber blanket. The rubber blanket serves as image transfer blanket, extends around the printing cylinder sleeve and is glued to this sleeve. In this case, two opposite edges of the rubber blanket form a seam.

It is a drawback of the known image transfer sleeve that the counter-pressure which the image transfer sleeve exerts on another printing cylinder is lost at the point in time when the seam rolls over the other printing cylinder. This effect is also known as channel impact and may cause vibrations in the offset printing press. Such vibrations may adversely affect the printing quality.

It is an object of the invention to solve the abovementioned problem at least partially or, at least, to provide a usable alternative. In particular, it is an object of the invention to provide an image transfer sleeve which causes fewer vibrations.

This object is achieved by an image transfer sleeve designed to be fitted around a mandrel of an offset printing press, according to claim 1.

An image transfer sleeve according to the invention is designed to be removably fitted around a mandrel of an offset printing press and comprises a printing cylinder sleeve and an image transfer blanket. The image transfer blanket extends around the printing cylinder sleeve and is connected to the printing cylinder sleeve by means of adhesive force. Two opposite edges of the image transfer blanket form a seam. The seam is at least partially wavy. The image transfer blanket is present along at least part of each describing line of the peripheral surface of the image transfer sleeve.

Due to the wavy seam and the presence of the image transfer blanket along each describing line, the plate cylinder maintains contact with the image transfer blanket while the seam is moving past. The same applies to the third cylinder, the latter making contact via the substrate. As a result, the counter-pressure is not lost, or at least is lost only to a lesser degree, resulting in no, or fewer, vibrations.

It should be noted that transfer cylinders with a wavy seam are known per se, for example form U.S. Pat. No. 5,778,787 and U.S. Pat. No. 5,732,630. However, these are undivided cylinders, i.e. cylinders without an exchangeable sleeve. In addition, in those publications, the rubber blanket is provided on a plate which is clamped and stretched in the cylinder. This is incompatible with a sleeve onto which a rubber blanket is glued.

According to U.S. Pat. No. 5,778,787, the shape of the seam is determined by the shape of the slot into which the plate is clamped. Thus, only a simple wavy shape, made up of two straight-line sections, is possible. In addition, it is not possible to adapt the wavy shape to modified wishes, circumstances or requirements.

Advantageous embodiments are defined in the subclaims.

Advantageously, the wavy seams comprise a plurality of wave crests and wave troughs. The result of this is that the angle of the various line sections of the wavy seams, i.e. the sections between a wave crest and a wave trough, relative to the axial direction of the image transfer cylinder can become larger, while the tangential distance around the image transfer cylinder over which the entire wavy seam extends remains the same. This leads to a further reduction in the risk of vibrations.

It should be noted that U.S. Pat. No. 5,778,787 shows plate cylinders having a slot which comprises more than two limbs, and therefore also several crests and troughs. However, these plate cylinders are designed to accommodate several printing plates, in each case two legs being intended for accommodating one printing plate. The respective printing plate thus has a seam with one peak and two troughs, just as the rubber blanket plates in this publication.

In one embodiment, the wavy seams comprise saw-tooth-like waves. Thus, an optimum angle can be chosen for the connecting line sections between wave crests and wave troughs, this angle being kept constant.

In an advantageous embodiment, the wave crests are rounded off, thus reducing the risk of such a crest becoming detached from a printing cylinder to which it is fitted.

In one embodiment, the wave form, amplitude and/or frequency of the wavy seams vary over the length of the edges. This is advantageous, for example, in order to adapt the course of the wavy seam to a print-free zone in a printing image which has to be transferred by the image transfer cylinder.

Expediently, the wavy edge is mirror-symmetrical relative to an imaginary plane which extends substantially halfway along the blanket and substantially at right angles to the wavy seams. Such symmetry ensures that an axial force, exerted on one side of the image transfer blanket when an oblique part of the wavy seam passes another printing cylinder, is cancelled out by a corresponding, but opposite, axial force exerted simultaneously on another part of the wavy seam.

The invention also relates to an offset printing press, provided with an image transfer sleeve.

In particular, the wavy seam substantially coincides with a wavy print-free zone of a plate cylinder interacting with an image transfer cylinder during printing. As a result, individual nested images can be optimally distributed on a plate cylinder, for example, without a rectilinear print-free zone having to be taken into account. The print-free zone may run between the nested images in the manner of an, in many cases, irregular, wavy shape. Since the wavy seam of the image transfer cylinder coincides with this print-free zone, the printing cylinders are used in an optimum manner.

Various embodiments of the invention will be explained in more detail below with reference to the accompanying drawings, in which:

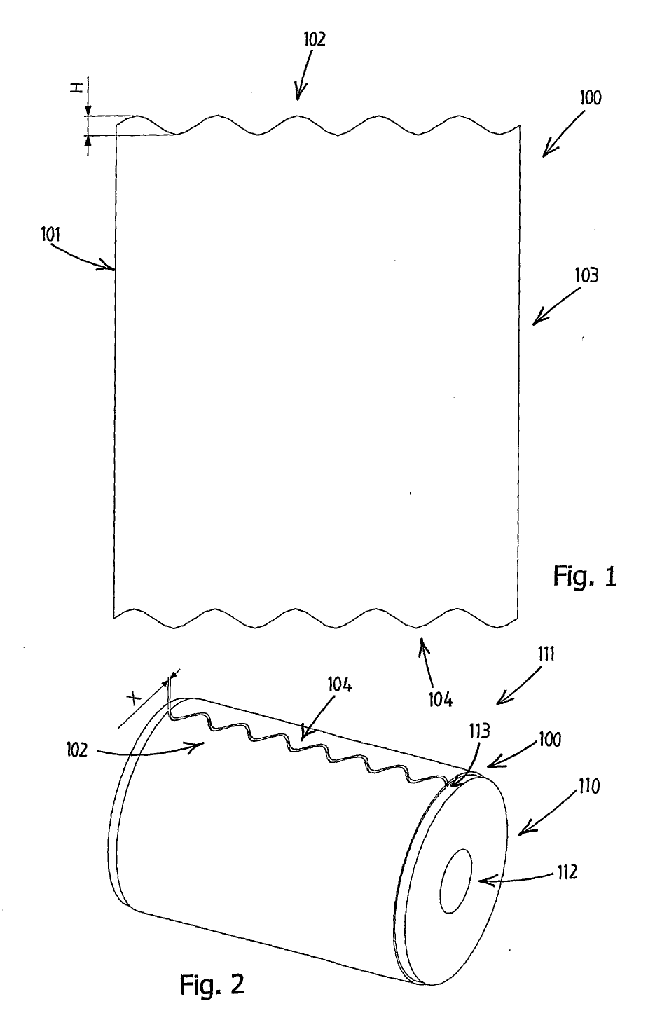

FIG. 1 shows a first embodiment of a rubber blanket according to the invention;

FIG. 2 shows an image transfer sleeve, provided with the rubber blanket from FIG. 1;

FIG. 3 shows an edge of a rubber blanket according to a second embodiment;

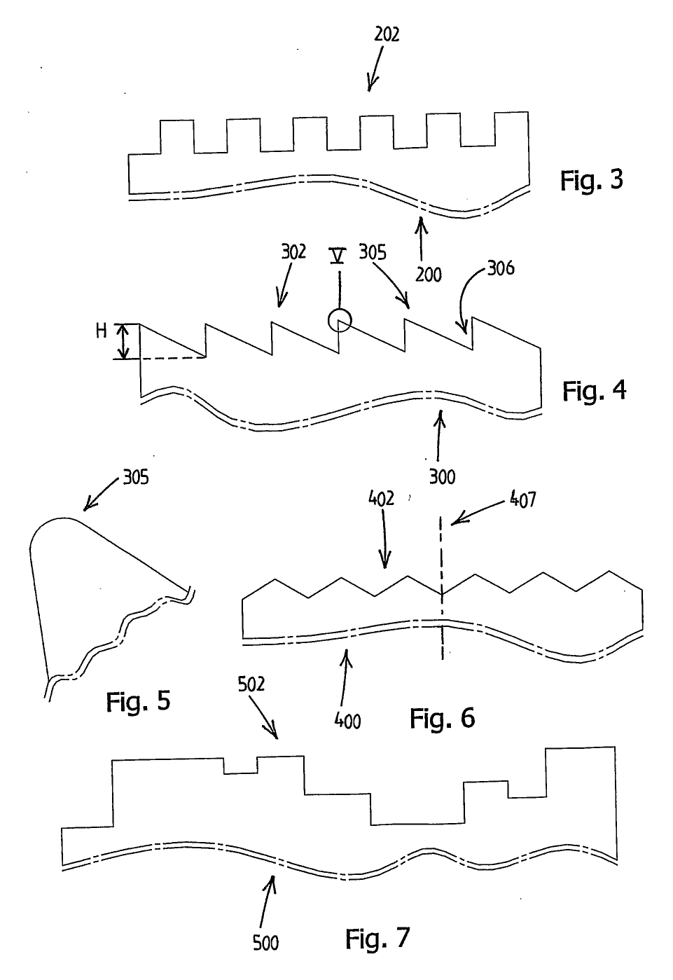

FIG. 4 shows an edge of a rubber blanket according to a third embodiment;

FIG. 5 shows a detail V from FIG. 4;

FIG. 6 shows an edge of a rubber blanket according to a fourth embodiment;

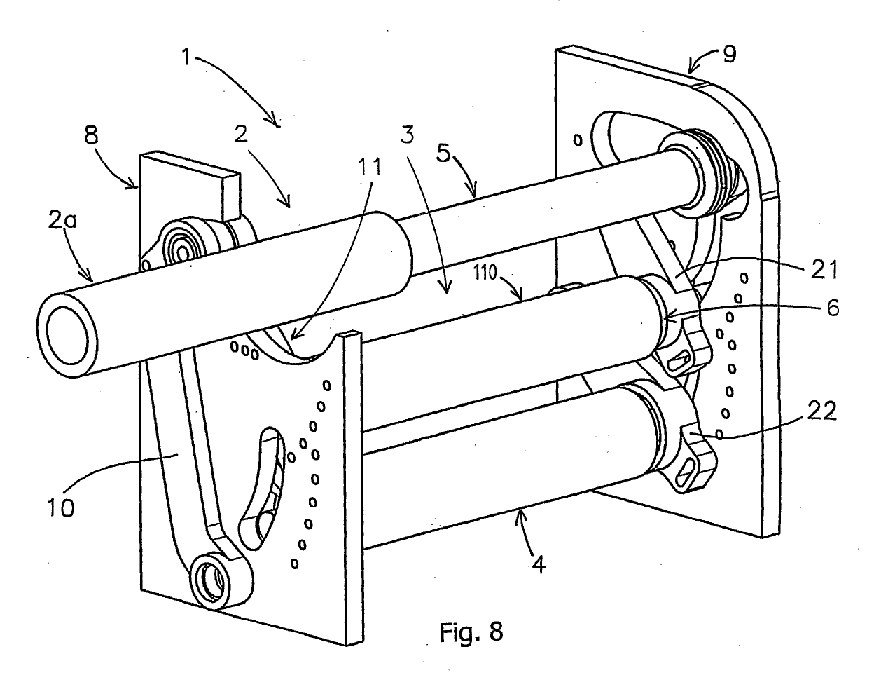

FIG. 7 shows an edge of a rubber blanket according to a fifth embodiment;

FIG. 8 shows an offset printing press with an image transfer sleeve.

In FIG. 1, a rubber blanket is denoted overall by reference numeral 100. In this case, the term rubber blanket is a standard term for an image transfer blanket, as this is generally composed of a number of layers, including a cotton base layer and a rubber top layer.

The rubber blanket 100 has four sides: 101, 102, 103, 104. The sides 101-104 are substantially at right angles to one another. In each case two sides form a pair of opposite sides. The two opposite sides 101 and 103 form the longitudinal edges of the rubber blanket 100. The two opposite sides 102 and 104 form the seam edges and are wavy—in this first examplary embodiment sinusoidal. The wavy edges 102 and 104 are shaped so as to be complementary. This means that at a specific position on a longitudinal edge, a protrusion or wave crest on one wavy side matches a recess or trough on the opposite wavy side.

FIG. 2 shows the rubber blanket 100 which is wound around a printing cylinder sleeve 110 in order to form an exchangeable image transfer sleeve or rubber blanket sleeve 111. The rubber blanket 100 and the rubber blanket sleeve 111 are connected by adhesive force, provided by glue. Gluing is advantageous as a thin-walled printing cylinder sleeve does not always provide sufficient space for a slot with clamping means, as such a slot may compromise the strength of a sleeve and because a light, for example plastic, printing cylinder sleeve may become unbalanced by a slot with clamping means.

The printing cylinder sleeve 110 is provided with a cylindrical opening 112 which extends concentrically around the centre axis of the sleeve 110. The printing cylinder sleeve 110 is thus suitable to be provided around a mandrel of an offset printing press (see FIG. 8).

With a regular wavy edge, a wave height H is defined as the difference between a wave crest and a wave trough. X is the width of the gap or seam 113 between the wavy edges 102 and 104 after the rubber blanket 100 has been fitted around the cylinder sleeve 110. In practice, X is very small and may, for example, be 1 mm. Nevertheless, a straight seam having a width of 1 mm may cause a second printing cylinder rolling over the image transfer sleeve to sense that the pressure which is present between this second cylinder and the sleeve 110 is lost for a very short time or is at least reduced. With an image transfer sleeve or cylinder with a straight seam, this causes a vibration in the offset printing cylinders. By ensuring that the value for H is at least greater than the value for X, the second printing cylinder will always maintain contact with the rubber blanket 100, as a result of which the mutual pressure is not lost, or at least is lost only to a lesser degree. In general, i.e. also in the case of wavy edges which vary in shape and/or wave height, as well as of seams of varying size, it is desirable for a rubber blanket to be at least partially present along each describing straight line of the peripheral surface of the rubber blanket fitted on a printing cylinder or printing sleeve. Peripheral surface is intended to mean the radial outer surface or cylindrical outer surface of a sleeve.

In contrast to the state of the art, the wave form of the seam is determined by the wave form shape of the edges of the image transfer blanket, and no longer by the shape of a slot in a printing cylinder. This makes it possible to change the shape of the seam in a simple manner by fitting a new image transfer blanket with the desired wave form on the edges of the blanket around a printing cylinder.

Furthermore, it is advantageous that different wave forms, such as waves with flowing forms and repeating wave forms, can be used.

FIG. 3 shows a part of an alternative rubber blanket 200 having a wavy edge 202. In this embodiment, the wavy edge is in the shape of a square wave. The rubber blanket 200 is designed to be wound around a printing cylinder sleeve in order to form a rubber blanket sleeve with a square-wave-shaped seam.

FIG. 4 shows a further embodiment of a part of a rubber blanket 300 with a wavy edge 302. In this variant, the wavy edge has a saw-tooth profile. The rubber blanket 300 is designed to be wound around a printing cylinder sleeve in order to form a rubber blanket sleeve with a saw-tooth-shaped seam. Such a saw-tooth profile has the advantage that it does not comprise any line sections running parallel to the axial direction of the sleeve or cylinder once the rubber blanket 300 has been fitted around a sleeve or cylinder. This reduces the risk of vibrations being caused by such a seam when it is passed over. In addition, the saw-tooth has the advantage that the oblique parts of the saw teeth can be given an angle relative to the said axial direction which is optimal from the point of view of preventing vibrations. At a given height H of the teeth, this means that a minimal number of teeth have to be formed.

FIG. 5 shows a detail V from FIG. 4. As can be seen, the tops of the saw-teeth, i.e. the wave crests 305, may be rounded off. This offers the advantage that the wave crests 305 will be less easily detached from the lower layer. Preferably, the shape of the saw-teeth is complementary to that of the saw-teeth on the other side (not shown) of the rubber blanket 300. This means that the wave troughs 306 may also be rounded off.

FIG. 6 shows an alternative embodiment of a part of a rubber blanket 400. The rubber blanket 400 has a wavy edge 402, the wave form comprising substantially straight-line sections. The points thus formed, which form the wave crests and wave troughs, may optionally be rounded off, as in the previous embodiment. The wavy edge is symmetrical relative to an imaginary mirror surface 407. The mirror surface 407 is at right angles to the wavy edge 402 and intersects this edge 402 midway along its length. The rubber blanket 400 is designed to be wound around a printing cylinder sleeve in order to form a rubber blanket sleeve with a square-wave-shaped seam.

FIG. 7 shows a part of a rubber blanket 500 with an alternative wavy edge 502. The wavy edge 502 consists of substantially straight-line sections, which are substantially at a right angle to one another. The line sections have different lengths. The wavy edge 502 thus formed may be regarded as a square wave, the frequency and amplitude, of which varies over the longitudinal direction of the edge. The rubber blanket 500 is designed to be wound around a printing cylinder sleeve in order to form a rubber blanket sleeve with a square-wave-shaped seam.

An irregular square-wave shape has the advantage that it can be matched to a print-free zone of a printing image which has to be transferred. Thus, it is possible to imagine a printing image comprising various separate images which are nested on a printing plate. As a result of the invention, a greater degree of freedom in nesting these images is provided. After all, the edges of the images no longer have to form a straight line over the entire width of the printing plate at any point. The edges of the various images can be staggered, as a result of which a square-wave-shaped print-free zone is created between the images. The wavy edge 502 of the rubber blanket 500 can be designed such that it coincides with this print-free zone.

FIG. 8 shows a printing cylinder support unit 1. The support unit 1 is accommodated in a printing tower (not shown) of an offset printing press. The support unit 1 may be permanently connected to the printing tower or may be accommodated therein in such a manner that it can be exchanged. In the latter case, this is referred to as a format assembly.

The support unit 1 supports three printing cylinders: a plate cylinder 2, a rubber blanket cylinder 3 and a counter-pressure roll 4. The plate cylinder 2 and the rubber blanket cylinder 3 each comprise a printing cylinder sleeve 2a or 110, respectively, and a mandrel 5 or 6, respectively. The printing cylinder sleeves 2a and 110 are provided on the mandrels 5 and 6 in such a manner that they can slide off. The printing cylinder sleeve 110 is provided with an image transfer blanket with a wavy seam (not visible in FIG. 8), for example a seam as described in connection with one of the preceding figures.

The support unit 1 comprises a frame of which only a frame front side 8 on the operating side and a frame rear side 9 on the drive side are shown for the sake of clarity. Three pairs of rotary arms are pivotably connected to the frame. A front plate cylinder arm 10, a front blanket cylinder arm 11 and a front counter-pressure roll arm (not visible in FIG. 8) are connected to the front frame 8. A rear plate cylinder arm (not visible in FIG. 8.), a rear blanket cylinder arm 21 and a rear counter-pressure roll arm 22 are connected to the rear frame 9 in a similar way.

Many variants are possible in addition to the embodiments shown. The wave forms shown may vary, with combinations of the various wave forms shown also being possible, optionally with any right or acute angles having been rounded off. In addition to the square wave with varying amplitude and frequency shown, it is also conceivable that other wave forms, including the sinusoidal and the saw-tooth shape, have a varying amplitude and frequency.

The wavy seam may be made up from both curved and straight-line sections. Such a straight-line section may be regarded as a part of the seam which is not wavy and changes over to a part of the seam which is wavy. The seam preferably does not comprise any straight-line sections running parallel to a centre axis of the printing cylinder sleeve. Preferably, the entire seam is wavy.

Preferably, the wave forms of two opposite edges of a rubber blanket are complementary. This is usually also preferable from the point of view of production. However, it is also possible that there are small differences between the wave forms, as a result of which the wavy seam eventually formed has a varying width.

It is also possible to use different materials as image transfer blanket instead of the conventional rubber blanket described. Thus, a blanket of this type may comprise a polymer.

The rubber blanket may also be connected to a printing cylinder or printing cylinder sleeve in a manner other than by gluing. Alternative means for providing adhesive force are, for example, a vacuum between cylinder and blanket, and magnets.

Thus, the invention provides an image transfer sleeve which prevents vibrations, or at least reduces them, by forming a wavy seam. In addition, the invention offers a degree of freedom regarding the choice of wave forms and dimensions and the possibility of adapting these forms to specific printing images and of modifying them in the interim.

1. Image transfer sleeve, designed to be removably fitted around a mandrel of an offset printing press, comprising a printing cylinder sleeve and an image transfer blanket,
which image transfer blanket extends around the printing cylinder sleeve and is connected to the printing cylinder sleeve by means of adhesive force,
in which two opposite edges of the image transfer blanket form a seam, wherein
the seam is at least partially wavy and
image transfer blanket is present along at least part of each describing line of the peripheral surface of the image transfer sleeve.

2. Image transfer sleeve according to claim 1, in which the wavy seam comprises several wave crests and several wave troughs.

3. Image transfer sleeve according to claim 1, in which the wavy seam comprises saw-tooth-like waves.

4. Image transfer sleeve according to claim 1, in which at least some of the wave crests are rounded off.

5. Image transfer sleeve according to claim 1, in which the wave form, amplitude and/or frequency of the wavy seam vary over the length of the seam.

6. Image transfer sleeve according to claim 1, in which the wavy seam is mirror-symmetrical relative to an imaginary plane which extends substantially halfway along the blanket and substantially at right angles to the wavy seam.

7. Image transfer sleeve according to claim 1, in which a wave height (H) of the wavy seam is at least equal to a width (X) of the seam.

8. Offset printing press, provided with an image transfer sleeve according to claim 1.

9. Offset printing press according to claim 8, in which the wavy seam of the image transfer blanket substantially coincides with a wavy print-free zone of a plate cylinder interacting with an image transfer cylinder during printing.
